(19) United States
(12) Patent Application Publication
(10) Pub. No.: US 2023/0214705 A1
(43) Pub. Date: Jul. 6, 2023

(54) MODEL-AGNOSTIC INPUT TRANSFORMATION FOR NEURAL NETWORKS

(71) Applicants: International Business Machines Corporation, Armonk, NY (US); The Board of Trustees of the University of Illinois, Urbana, IL (US)

(72) Inventors: Pin-Yu Chen, White Plains, NY (US); Nandhini Chandramoorthy, YORKTOWN HEIGHTS, NY (US); Karthik V Swaminathan, Mount Kisco, NY (US); Jinjun Xiong, Goldens Bridge, NY (US); Devansh Paresh Shah, Champaign, IL (US); Bo Li, Champaign, IL (US)

(21) Appl. No.: 17/566,624

(22) Filed: Dec. 30, 2021

(51) Int. Cl. G06N 20/00; G06N 5/04

(52) U.S. Cl. CPC G06N 20/00; G06N 5/04

(57) ABSTRACT

An input transformation function that transforms input data for a second machine learning system is learned using a first machine learning system, the learning being based on minimizing a summation of a task loss and a post-activation density loss. The input data is transformed using the learned input transformation function to alter the post-activation density to reduce an amount of energy consumed for an inferencing task and the inferencing task is carried out on the transformed input data using the second machine learning system.

### BACKGROUND

The present invention relates to the electrical, electronic and computer arts, and more specifically, to improved machine learning systems.

The training and use of artificial intelligence (AI) models can consume substantial amounts of energy. To mitigate the negative consequences of this effect, various techniques have been developed. Conventional methods for reducing the carbon footprint of AI systems often consider reducing energy consumption at training time, not inference time (i.e., current techniques do not consider reducing the energy consumption of an inference application programming interface (API); it is hard for current inference APIs to dynamically adjust energy consumption level by demand). Other techniques for reducing energy consumption consider model compression or reduced-precision hardware for constraining the machine precision.

### SUMMARY

Principles of the invention provide techniques for model-agnostic input transformation for neural networks. In one aspect, an exemplary method includes the operations of learning, using a first machine learning system, an input transformation function that transforms input data for a second machine learning system, the learning being based on minimizing a summation of a task loss and a post-activation density loss; transforming the input data using the learned input transformation function to alter the post-activation density to reduce an amount of energy consumed for an inferencing task; and carrying out the inferencing task on the transformed input data using the second machine learning system.

In one aspect, a non-transitory computer readable medium comprises computer executable instructions which when executed by a computer cause the computer to perform the method of learning, using a first machine learning system, an input transformation function that transforms input data for a second machine learning system, the learning being based on minimizing a summation of a task loss and a post-activation density loss; transforming the input data using the learned input transformation function to alter the post-activation density to reduce an amount of energy consumed for an inferencing task; and carrying out the inferencing task on the transformed input data using the second machine learning system.

In one aspect, an apparatus comprises a memory and at least one processor, coupled to the memory, and operative to perform operations comprising learning, using a first machine learning system, an input transformation function that transforms input data for a second machine learning system, the learning being based on minimizing a summation of a task loss and a post-activation density loss; transforming the input data using the learned input transformation function to alter the post-activation density to reduce an amount of energy consumed for an inferencing task; and carrying out the inferencing task on the transformed input data using the second machine learning system.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

inference-time energy reduction;

energy-saving techniques agnostic to model compression and reduced precision;

neural energy saving functions that can be configured for different hardware architectures;

customizable energy metric for underlying sparsity-aware hardware, such as activation density and other energy-related metrics suitable for learning a corresponding neural energy saver for reducing energy cost; and

dynamic adjustment (on-the-fly) of an energy-accuracy tradeoff.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a high-level block diagram of an energy-saving neural network system, in accordance with an example embodiment;

FIG. 2 is an overview of an example workflow for attaining energy saving in the neural network utilizing the transformation module, in accordance with an example embodiment;

FIG. 3 is a table illustrating the tradeoff between accuracy and activation density for an example configuration, in accordance with an example embodiment;

FIG. 4 is a table illustrating the effectiveness of energy saving using different conventional models, in accordance with an example embodiment;

FIG. 5 is an overview of a hardware simulation infrastructure for energy per instruction measurement, in accordance with an example embodiment;

FIG. 6 is a table illustrating the energy reduction through sparsity exploitation in the Neural Energy Saver model, in accordance with an example embodiment;

FIG. 7 depicts a cloud computing environment according to an embodiment of the present invention;

FIG. 8 depicts abstraction model layers according to an embodiment of the present invention; and

FIG. 9 depicts a computer system that may be useful in implementing one or more aspects and/or elements of the invention, also representative of a cloud computing node according to an embodiment of the present invention.

### DETAILED DESCRIPTION

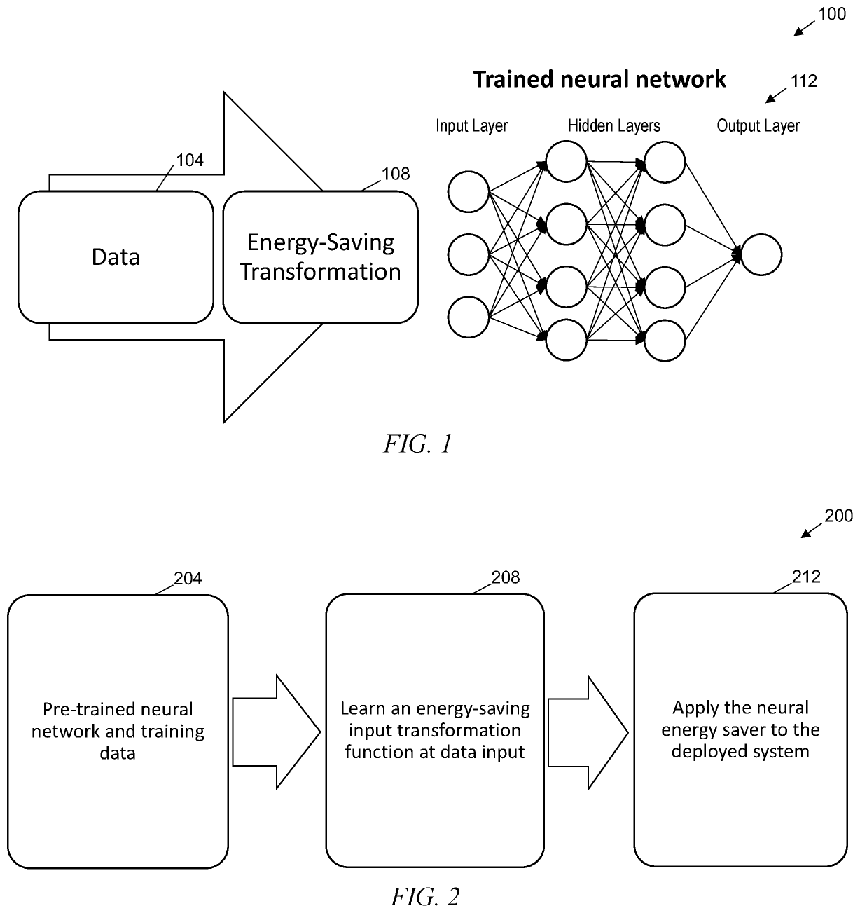

FIG. 1 is a high-level block diagram of an energy-saving neural network system 100, in accordance with an example embodiment. The energy-saving neural network system 100 includes a neural network 112 and an energy-saving transformation module 108. As depicted in FIG. 1, the neural network 112 includes an input layer, a number of hidden layers, and an output layer. A conventional neural network inputs data directly into the input layer, potentially resulting in the consumption of a relatively large amount of energy in the processing of the input data 104. In one example embodiment, data 104 is transformed by an energy-saving transformation module 108 prior to processing by the trained neural network 112 resulting in a significant energy saving during the inference phase.

FIG. 2 is an overview of an example workflow 200 for attaining energy saving in the neural network 112 utilizing the transformation module 108, in accordance with an example embodiment. Pretrained neural networks 112 and training data are obtained (operation 204). It is noted that the energy-saving neural network system 100 is agnostic to different pre-trained neural network models (that are characterized by rectified linear (ReLU) activation where the minimum activation value is zero), model compression, and prediction reduction. An energy-saving input transformation function for reducing energy consumption in a neural network 112 is learned (operation 208). Multiple neural energy saver transformation functions can be learned to enable implementation of different levels of energy saving. The neural energy saver is applied to the deployed system 100 by transforming the input data 104 using one of the learned transformation functions prior to processing by the neural network 112 (operation 212). Inference power consumption is reduced and an on-demand tradeoff between energy and performance (via selection of a particular transformation function) is provided.

Learning a Neural Energy-Saving Function

In one example embodiment, the post-ReLU activation density is used as an energy metric, since denser levels of activations generally consume more energy. Given a data input x, the number of non-zero activation values is defined as Σ_{z∈all post activation values} 1[z(x)≠0], where 1 is a binary indication function. By transforming the input data 104 such that the number of non-zero activation values is reduced, energy saving during the inference phase can be attained.

In one example embodiment, given a pre-trained model, a parametrized input transformation function g_{θ} (data input) of the transformation module 108 is trained (using training data) with the following objective:

Minimize_{θ}Lossₜₐₛₖ(θ)+λ·Loss_{density}(θ)

where θ represents the parameters of the input transformation function, where the first loss (Lossₜₐₛₖ) ensures satisfactory accuracy for the task while the second loss (Loss_{density}) ensures that the density of the post-activations will be sufficiently small to attain the energy saving. λ serves to balance the two losses, thereby enabling a tradeoff between accuracy and energy consumption. In one example embodiment, the input transformation function is trained with the same training samples used to train the neural network 112. The transformation module 108 can be implemented, for example, by high-level code that encodes the logic disclosed herein and is then compiled or interpreted into computer-executable instructions.

In one example embodiment, multiple θ (transformation) functions are trained with different values of λ. A user may then select a value for A (or another parameter that corresponds to λ, as described more fully below) and the corresponding transformation function will be utilized to transform the input data 104 prior to processing by the neural network 112. Thus, an on-demand adjustment of energy saving versus accuracy may be attained (that is, neural energy savers with different levels of energy saving and accuracy).

In one example embodiment, an additive function is used by setting

g_{θ(x)}=x+θ, where θ is universal to all data inputs.

After transformation, the input data to the neural network 112 will be based on g_{θ(x)}=x+θ. In one example embodiment, the losses are defined as:

Lossₜₐₛₖ(θ) as the task-specific loss; and

Loss_{density}(θ)=Σ_{z∈all post activation values}tanh[z(x+θ)].

where tanh is used to approximate the 0-1 loss for post-activation density and A controls the energy-accuracy tradeoff. More complex g_{θ(x) functions, such as a non-linear function, are also contemplated.}

In one example embodiment, to activate the energy saving mode, a user simply enables or disables the energy saving mode (where no transformation is utilized, or equivalently, where λ is set to zero, when the energy saving mode is disabled; and where λ is set to a user-selected or predefined value when the energy saving mode is enabled).

In one example embodiment, energy measurements are obtained for each of a plurality of ranges of activation density for a given hardware platform and a given neural network model. A table is created that associates the energy measurement and/or energy saving (such as an energy saving percentage) with the accuracy level, the value of λ, the transformation function, or any combination thereof. The table may be utilized to select the value of λ based on a selected accuracy level, energy consumption level or energy saving level, as defined in the table. In one example embodiment, a user may specify an accuracy level, a density value, an energy level, or an energy saving percentage and the appropriate transformation function will be selected based on the corresponding value of λ.

Performance Evaluation

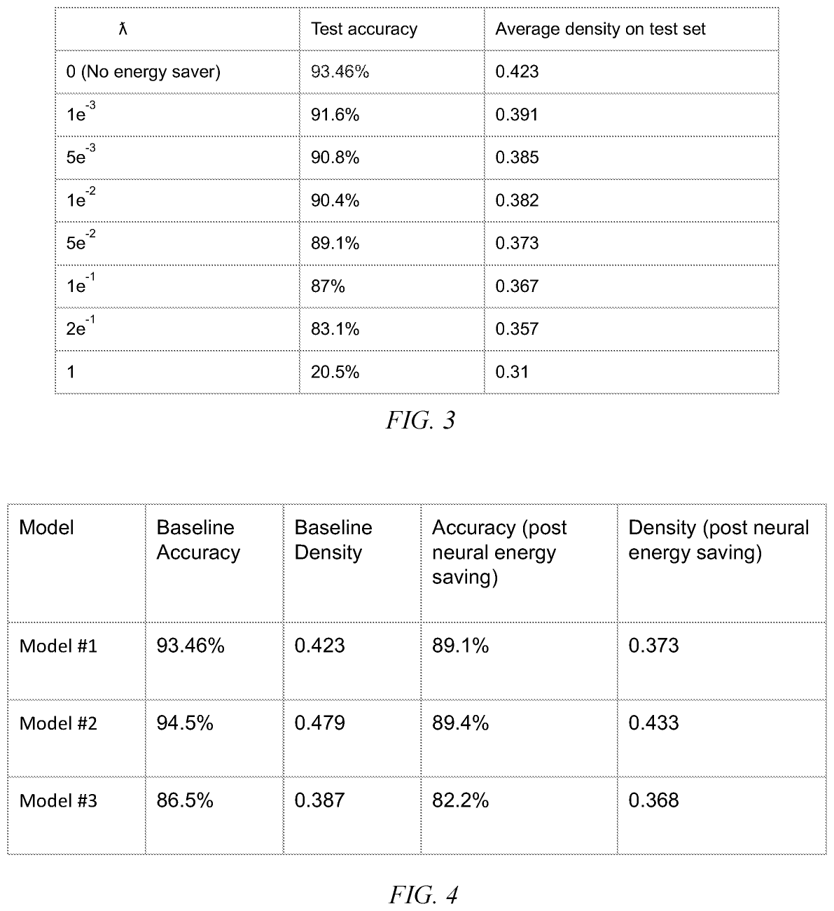

An exemplary embodiment was evaluated on three model architectures pre-trained on a conventional classification task (a dataset containing over 50,000 color images corresponding to a plurality of classes, with over 5,000 images per class) and a simulated sparsity-aware hardware assessment for energy evaluation. FIG. 3 is a table illustrating the tradeoff between accuracy and activation density for an example configuration, in accordance with an example embodiment. As evidenced by the table of FIG. 3, increasing A and the corresponding energy saving leads to a reduction in total accuracy and a reduction in the average density on the test set (where density for a data point=non-zero activations/total activations; and the average density on test set=average of density on all test set data samples).

Effectiveness on Different Networks

FIG. 4 is a table illustrating the effectiveness of energy saving using different conventional models, in accordance with an example embodiment. In the example of FIG. 4, λ=5e⁻². As depicted in FIG. 4, each model has a corresponding baseline accuracy, baseline density, accuracy (post neural energy saving), and density (post neural energy saving).

In one example embodiment, energy reduction is achieved through sparsity exploitation in a hardware accelerator. The reduction in dynamic energy is estimated during the computation of the convolution layers with the disclosed neural energy saver model compared to the baseline model. The type of accelerator considered was outer-product based matrix multiplication (for example, a commercially available math hardware accelerator on a modern high-end processor, such as the Inline Matrix Math Accelerator (MMA) with the IBM POWER 10 processor (POWER® is a registered trademark of International Business Machines Corporation (IBM), Armonk, N.Y., USA)) where the convolution operation is implemented as vector-vector outer product matrix multiplication using fine-grain instructions in MMA, where each instruction performs 16 multiply operations. A reduction in computation energy was possible through two architectural features that were added to exploit the activation sparsity:

A) reduce dynamic energy with skipped instructions: skip an instruction when the operand (4-element activation vector) is zero-valued using conditional execution; and

B) reduce dynamic energy with skipped computations per instruction: skip specific operations in an instruction using an element-wise mask, corresponding to zero-valued elements in the 4-element activation vector.

Energy Estimation Methodology

For both features A and B, the convolution layers of the model were mapped into MMA instructions to accelerate general matrix multiply (GEMINI) and, consequently, convolution in deep neural network (DNN) inference tasks, as described in the IBM paper by Moreira, José E., et al. “A matrix math facility for Power ISA™ processors,” arXiv preprint arXiv: 2104.03142 (2021). The MIVIA unit runs rank-k update operations, in which the outer product of two matrices is accumulated into an output matrix. The MMA instructions use 128-bit vector-scalar registers for input and separate 512-bit accumulator registers for the output, enabling a 4×4 32-bit matrix multiplication operation. Two-dimensional and three-dimensional convolution between a kernel and an image is carried out through a sequence of outer-product based matrix multiply operations.

Operand sparsity for each instruction in each convolutional layer, and the number of such instructions, was obtained. The total dynamic energy (which is dependent on workload) for computation of the convolution layers (inter-instruction) is defined as:

$${\sum }_{i} \begin{matrix}\begin{matrix}( Total \# of MMA instructions in the convolution layer [ i ] - \\ \# of sparse MMA instructions skipped in the convolution layer [ i ] ) *\end{matrix} \\ energy per MMA instruction )\end{matrix}$$

The total dynamic energy for computation of the convolution layers (intra-instruction) is defined as:

$${\sum }_{i} \begin{matrix}\sum j ( MMA instructions [ i , j ] * \\ \begin{matrix}fraction of ops skippped in instruction [ i , j ] ) * \\ energy per MMA instruction\end{matrix}\end{matrix} ,$$

where i denotes the convolution layer index and j denotes the instruction index for convolution layer i. The energy per MMA instruction was obtained through hardware simulations and the energy per MMA instruction was obtained using random operands.

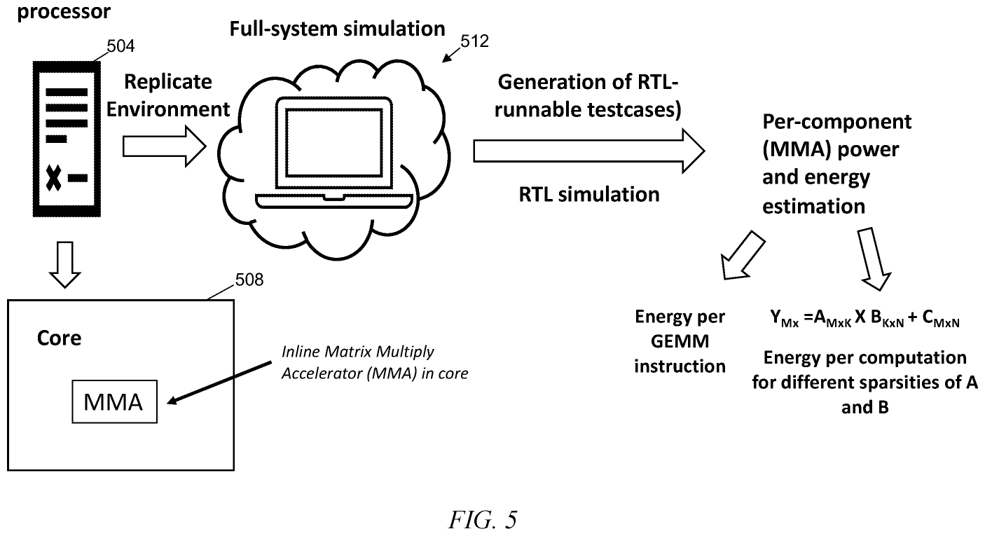

FIG. 5 is an overview of a hardware simulation infrastructure for energy per instruction measurement, in accordance with an example embodiment. A processor 504 having a core 508 with an inline Matrix Multiply Accelerator was used to perform two valuations: a) run single matrix multiply (known general matrix multiplication techniques) instruction that performs an outer product of two m×m matrices, initialized to random values (where m=4 for the example embodiment utilizing core 508); and b) run general matrix multiplication program including a multiplication of matrices of dimensions M×N and N×K, each initialized to different sparsity levels (M,N,K>>m). The environment was replicated to create a full-system simulation environment 512 where the generation of register transfer level (RTL)-runnable testcases enabled a register transfer level (RTL) simulation. The per-component (MMA) power and energy estimation, including energy per general matrix multiplication instruction and energy per computation for different sparsities of A and B (Y_{Mx}=A_{MxK}×B_{KxN}+C_{MxN}), was performed utilizing the RTL simulation.

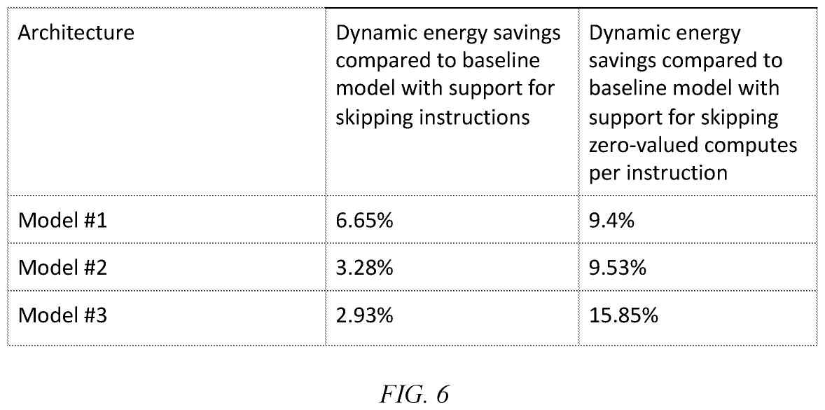

FIG. 6 is a table illustrating the energy reduction through sparsity exploitation in the Neural Energy Saver model, in accordance with an example embodiment. Although the sample evaluation embodiment is the outer-product based MMA, the neural energy saver model will result in energy savings in other types of accelerator architectures, such as commercially available systolic array based spatial convolution accelerators (a non-limiting example is IBM's RaPID accelerator with sparsity support).

Given the discussion thus far, it will be appreciated that, in general terms, an exemplary method, according to an aspect of the invention, includes the operations of learning, using a first machine learning system, an input transformation function 108 that transforms input data 104 for a second machine learning system, the learning being based on minimizing a summation of a task loss and a post-activation density loss; transforming the input data 104 using the learned input transformation function 108 to alter the post-activation density to reduce an amount of energy consumed for an inferencing task; and carrying out the inferencing task on the transformed input data using the second machine learning system.

In one example embodiment, the second machine learning system is implemented with a neural network 112. In one example embodiment, the learning of the input transformation function 108 comprises balancing a task-specific loss and the post-activation density of the neural network 112 at inference time based on a specified tradeoff factor. In one example embodiment, the learning operation is repeated at different specified tradeoff factors to generate additional input transformation functions 108, wherein the transforming operation is performed using a selected one of the input transformation functions 108 corresponding to a selected tradeoff factor of the specified tradeoff factors.

In one example embodiment, the selection of one of the input transformation functions 108 is obtained. In one example embodiment, the obtained selection is one of: the selected tradeoff factor, an energy level, an energy saving level, an identification of one of the input transformation functions 108, and an accuracy level. In one example embodiment, the task loss ensures satisfactory accuracy for the inferencing task while the post-activation density loss ensures that a density of post-activations will be sufficiently small to attain the reduced energy consumption, and wherein each specified tradeoff factor serves to balance the task loss and the post-activation density loss to enable a tradeoff between the accuracy and the energy consumption.

In one aspect, a non-transitory computer readable medium comprises computer executable instructions which when executed by a computer cause the computer to perform the method of learning, using a first machine learning system, an input transformation function 108 that transforms input data 104 for a second machine learning system, the learning being based on minimizing a summation of a task loss and a post-activation density loss; transforming the input data 104 using the learned input transformation 108 function to alter the post-activation density to reduce an amount of energy consumed for an inferencing task; and carrying out the inferencing task on the transformed input data using the second machine learning system.

In one aspect, an apparatus comprises a memory and at least one processor, coupled to the memory, and operative to perform operations comprising learning, using a first machine learning system, an input transformation function 108 that transforms input data 104 for a second machine learning system, the learning being based on minimizing a summation of a task loss and a post-activation density loss; transforming the input data 104 using the learned input transformation function 108 to alter the post-activation density to reduce an amount of energy consumed for an inferencing task; and carrying out the inferencing task on the transformed input data using the second machine learning system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

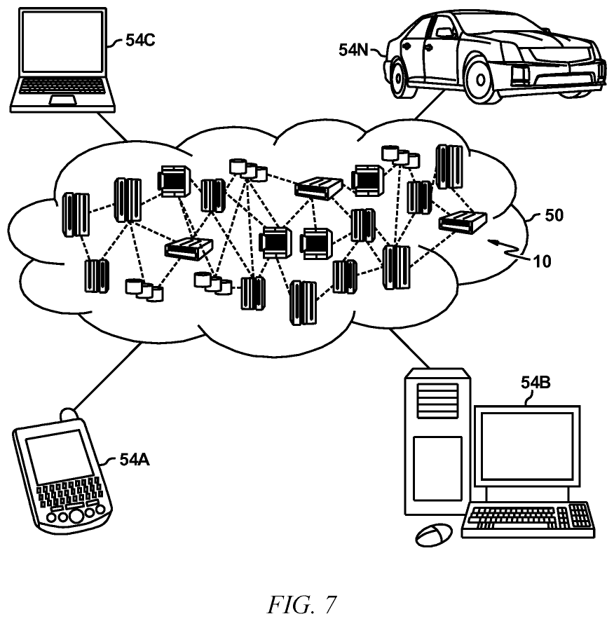

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

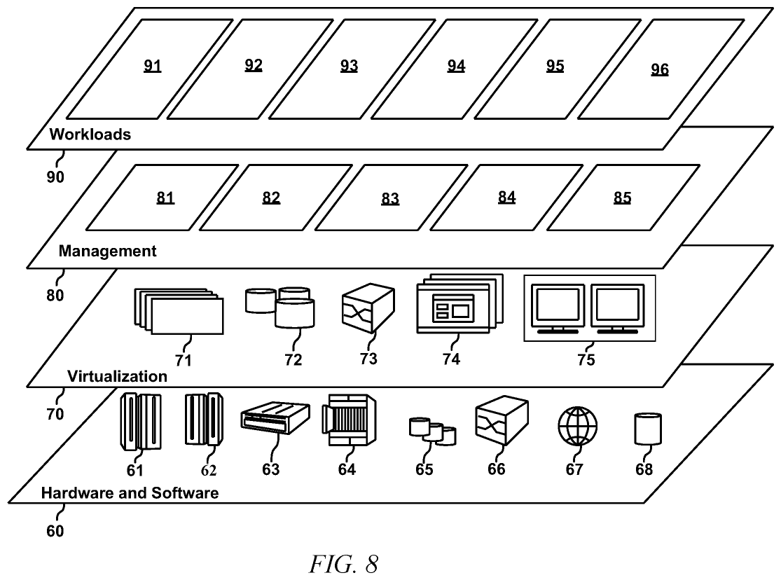

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and at least a portion of a neural network transformer 96 (for example, one non-limiting use case is a local user owning a model and using a cloud environment to obtain such Neural Energy Server through cloud training).

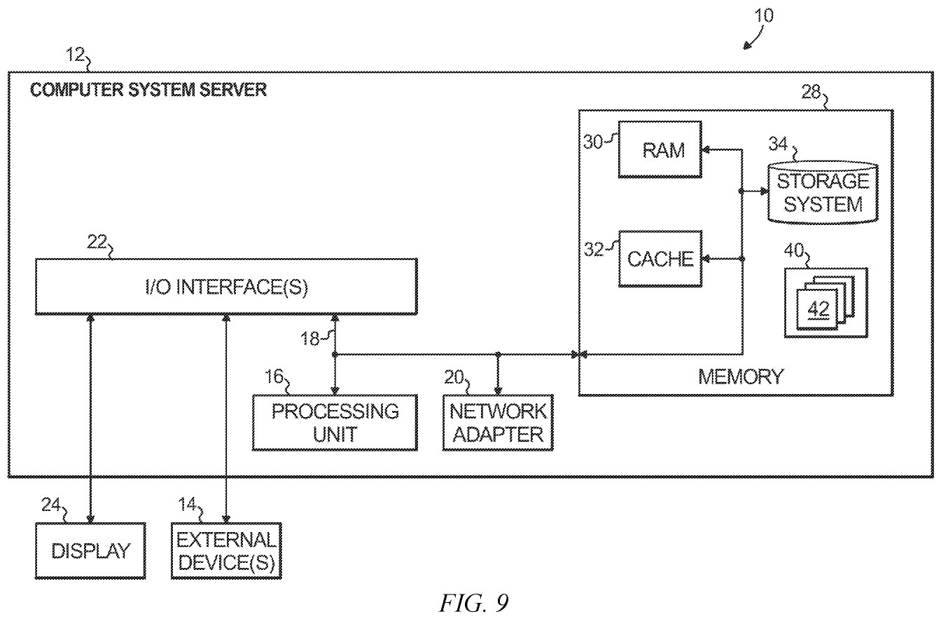

One or more embodiments of the invention, or elements thereof, can be implemented in the form of an apparatus including a memory and at least one processor that is coupled to the memory and operative to perform exemplary method steps. FIG. 9 depicts a computer system that may be useful in implementing one or more aspects and/or elements of the invention, also representative of a cloud computing node according to an embodiment of the present invention. Referring now to FIG. 9, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 9, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 9) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 7-8 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
learning, using a first machine learning system, an input transformation function that transforms input data for a second machine learning system, the learning being based on minimizing a summation of a task loss and a post-activation density loss;
transforming the input data using the learned input transformation function to alter the post-activation density to reduce an amount of energy consumed for an inferencing task; and
carrying out the inferencing task on the transformed input data using the second machine learning system.

2. The method of claim 1, wherein the second machine learning system is implemented with a neural network.

3. The method of claim 2, wherein the learning of the input transformation function comprises balancing a task-specific loss and the post-activation density of the neural network at inference time based on a specified tradeoff factor.

4. The method of claim 1, further comprising repeating the learning operation at different specified tradeoff factors to generate additional input transformation functions, wherein the transforming operation is performed using a selected one of the input transformation functions corresponding to a selected tradeoff factor of the specified tradeoff factors.

5. The method of claim 4, further comprising obtaining the selection of one of the input transformation functions.

6. The method of claim 5, wherein the obtained selection is one of: the selected tradeoff factor, an energy level, an energy saving level, an identification of one of the input transformation functions, and an accuracy level.

7. The method of claim 4, wherein, in the learning step, the task loss ensures satisfactory accuracy for the inferencing task while the post-activation density loss ensures that a density of post-activations will be sufficiently small to attain the reduced energy consumption, and wherein each specified tradeoff factor serves to balance the task loss and the post-activation density loss to enable a tradeoff between the accuracy and the energy consumption.

8. A non-transitory computer readable medium comprising computer executable instructions which when executed by a computer cause the computer to perform the method of:
learning, using a first machine learning system, an input transformation function that transforms input data for a second machine learning system, the learning being based on minimizing a summation of a task loss and a post-activation density loss;
transforming the input data using the learned input transformation function to alter the post-activation density to reduce an amount of energy consumed for an inferencing task; and
carrying out the inferencing task on the transformed input data using the second machine learning system.

9. The non-transitory computer readable medium of claim 8, wherein the second machine learning system is implemented with a neural network.

10. The non-transitory computer readable medium of claim 9, wherein the learning of the input transformation function comprises balancing a task-specific loss and the post-activation density of the neural network at inference time based on a specified tradeoff factor.

11. The non-transitory computer readable medium of claim 8, the method further comprising repeating the learning operation at different specified tradeoff factors to generate additional input transformation functions, wherein the transforming operation is performed using a selected one of the input transformation functions corresponding to a selected tradeoff factor of the specified tradeoff factors.

12. The non-transitory computer readable medium of claim 11, the method further comprising obtaining the selection of one of the input transformation functions.

13. The non-transitory computer readable medium of claim 12, wherein the obtained selection is one of: the selected tradeoff factor, an energy level, an energy saving level, an identification of one of the input transformation functions, and an accuracy level.

14. An apparatus comprising:
a memory; and
at least one processor, coupled to said memory, and operative to perform operations comprising:
learning, using a first machine learning system, an input transformation function that transforms input data for a second machine learning system, the learning being based on minimizing a summation of a task loss and a post-activation density loss;
transforming the input data using the learned input transformation function to alter the post-activation density to reduce an amount of energy consumed for an inferencing task; and
carrying out the inferencing task on the transformed input data using the second machine learning system.

15. The apparatus of claim 14, wherein the second machine learning system is implemented with a neural network.

16. The apparatus of claim 15, wherein the learning of the input transformation function comprises balancing a task-specific loss and the post-activation density of the neural network at inference time based on a specified tradeoff factor.

17. The apparatus of claim 14, the operations further comprising repeating the learning operation at different specified tradeoff factors to generate additional input transformation functions, wherein the transforming operation is performed using a selected one of the input transformation functions corresponding to a selected tradeoff factor of the specified tradeoff factors.

18. The apparatus of claim 17, the operations further comprising obtaining the selection of one of the input transformation functions.

19. The apparatus of claim 18, wherein the obtained selection is one of: the selected tradeoff factor, an energy level, an energy saving level, an identification of one of the input transformation functions, and an accuracy level.

20. The apparatus of claim 17, wherein the task loss ensures satisfactory accuracy for the inferencing task while the post-activation density loss ensures that a density of post-activations will be sufficiently small to attain the reduced energy consumption, and wherein each specified tradeoff factor serves to balance the task loss and the post-activation density loss to enable a tradeoff between the accuracy and the energy consumption.
